(19) United States
(12) Patent Application Publication
(10) Pub. No.: US 2010/0053006 A1
(43) Pub. Date: Mar. 4, 2010

(54) Antenna Device

(76) Inventors: Akira Miyoshi, Tokyo (JP); Hisamatsu Nakano, Tokyo (JP); Junji Yamauchi, Tokyo (JP); Ryohei Satake, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/548,585

(22) Filed: Aug. 27, 2009

(30) Foreign Application Priority Data
Aug. 28, 2008 (JP) P2008-219077

(51) Int. Cl. H01Q 11/12; H01Q 9/04

(52) U.S. Cl. 343/742; 343/700 MS

(57) ABSTRACT

An antenna device includes a plurality of loop elements. The loop elements are made of conductive material, and constitute a planar antenna element having N-fold rotationally symmetric shape with respect to a center portion of the planar antenna element, the N being an integer of three or more. Each of the loop elements includes at least two first elements extending in a first direction parallel to a radial direction of the planar antenna element and at least one second element extending in a circumferential direction of the planar antenna element. A ground plate is made of conductive material and opposes the planar antenna element. A power feeding line extends from the ground plate to the planar antenna element, and is electrically connected to the planar antenna element at the center portion.

### BACKGROUND

The present invention relates to an antenna device and, more particularly, to antenna device designed for radiating a circularly-polarized wave.

As is well known in this technical field, a loop antenna element has hitherto been known as one type of an antenna device that radiates a circularly polarized wave.

With reference to FIGS. 1 and 2, a conventional loop antenna element 60 is described below. As shown in FIG. 1, in an orthogonal coordinate system (x, y, z), the center of a ground plate 64 is labeled as the origin to be described later. The x-axis represents a longitudinal direction of the ground plate 64; the y-axis represents a lateral direction of the ground plate 64; and the z-axis represents a height direction of the ground plate 64. Therefore, the direction z is a normal direction of the ground plate 64. In FIG. 2, a direction orthogonal to a drawing sheet corresponds to the x-axis; the lateral direction of the drawing sheet corresponds to the y-axis; and a longitudinal direction of the drawing sheet corresponds to the z-axis.

The loop antenna element 60 comprises a loop-shaped radiation element 62; a ground plate 64 opposing the radiation element 62; and a feeder line 66 extending upward in the z-axis direction from the ground plate 64 toward the radiation element 62. The ground plate 64 and the radiation element 62 are arranged substantially parallel to each other.

The ground plate 64 extends within a plane parallel to an x-y plane defined by the x-axis and the y-axis. A feeding point 66a of the feeder line 66 is arranged at the substantial center of the ground plate 64. An insulator 64a, such as a through hole, is provided at the center of the ground plate 64. Consequently, the feeding point 66a and the ground plate 64 are not electrically connected to each other.

The loop antenna element 60 is supplied with power feed by use of a coaxial cable 70 shown in FIG. 2. The coaxial cable 70 is an electrical signal transmitting member that has a coaxial configuration including a cylindrical outer conductor 72 and a center conductor 74 disposed at the center of the cable. The outer conductor 72 and the center conductor 74 are insulated from each other by a cylindrical insulator 76. The outer conductor 72 is covered with a sheath (not shown).

As shown in FIG. 2, a leading end of the center conductor 74 of the coaxial cable 70 is electrically connected to the feeding point 66a by solder (not shown), and a leading end of the outer conductor 72 of the coaxial cable 70 is electrically connected to the ground plate 64 by solder (not shown).

As shown in FIG. 2, the conventional loop antenna element 60 exhibits a circular-polarized-wave characteristic in the normal direction of the radiation element 62.

A curled antenna element has also been known as an antenna element similar to the loop antenna element 60. For instance, the curled antenna elements disclosed in Patent Documents 1 and 2 have a three-dimensional structure and have a ground plane opposing the antenna element in parallel, thereby facilitating impedance matching. The loop antenna element 60 shown in FIGS. 1 and 2 and the curled antenna elements disclosed in Patent Documents 1 and 2 serve as directional antennas exhibiting a high gain in a direction of the zenith by the ground plane opposing the antenna element.

[Patent Document 1] Japanese Patent Publication No. 2007-235460 A

[Patent Document 2] Japanese Patent Publication No. 2003-218632 A

In the loop antenna element 60 shown in FIGS. 1 and 2 and the curled antenna elements disclosed in Patent Documents 1 and 2, a circularly polarized wave is radiated in the normal direction with respect to the loop plane where the radiation element 62 extends.

### SUMMARY

It is therefore one advantageous aspect of the present invention to provide an antenna element that radiates a nondirectional circularly-polarized wave within an antenna plane (horizontal plane).

According to one aspect of the invention, there is provided an antenna device, comprising:

a plurality of loop elements made of conductive material, and constituting a planar antenna element having N-fold rotationally symmetric shape with respect to a center portion of the planar antenna element, the N being an integer of three or more, each of the loop elements including:
at least two first elements extending in a first direction parallel to a radial direction of the planar antenna element; and
at least one second element extending in a circumferential direction of the planar antenna element;

a ground plate made of conductive material and opposing the planar antenna element; and

a power feeding line extending from the ground plate to the planar antenna element, and electrically connected to the planar antenna element at the center portion.

The antenna device may be configured such that: a dielectric substrate on which the planar antenna element mounted.

The antenna device may be configured such that: the dielectric substrate has circular shape.

The antenna device may be configured such that: a gap is formed between the dielectric substrate and the ground plate.

The antenna device may be configured such that: the planar antenna element has circular shape.

The antenna device may be configured such that: the ground plate has square shape.

The antenna device may be configured such that: a radius of the planar antenna element is 1.5 times a length of a side of the ground plate.

The antenna device may be configured such that: each of the loop elements includes a peripheral portion forming an outer periphery of the planar antenna element; and a length of the peripheral portion is three-fifths of a working wavelength obtained by shortening a wavelength corresponding to working frequency of the antenna device with the dielectric substrate.

The antenna device may be configured such that: the N is multiple of four.

The antenna device may be configured such that: the N is four.

The antenna device may be configured such that: each of the loop elements swirls clockwise when viewed from a side of the planar antenna element opposite to a side that the ground plate is disposed so as to radiate right-handed circularly polarized waves.

### BRIEF DESCRIPTION OF THE DRAWINGS

FIG. 1 is a perspective view of a conventional loop antenna element.

FIG. 2 is a front view showing the conventional loop antenna element with its radiation characteristic.

FIG. 3 is a perspective view of an antenna device according to one embodiment of the present invention.

FIG. 4 is a plan view of the antenna device shown in FIG. 3.

FIG. 5 is a left side view of the antenna shown in FIG. 3.

FIG. 6 is a front view of the antenna device shown in FIG. 3.

FIG. 7 is a front view of the antenna device shown in FIG. 3 with its radiation characteristic.

FIG. 8 is a plane view showing a spiral conductor pattern of the antenna device shown in FIG. 3.

FIG. 9A shows a radiation pattern of the antenna device shown in FIG. 3 acquired in a case where the height thereof is 5 mm;

FIG. 9B shows a radiation pattern of the antenna device shown in FIG. 3 acquired in a case where the height thereof is 8 mm; and

FIG. 9C shows a radiation pattern of the antenna device shown in FIG. 3 acquired in a case where the height thereof is 11 mm.

FIG. 10A shows an axial ratio pattern of the antenna device shown in FIG. 3 acquired in a case where the height thereof is 5 mm.

FIG. 10B shows an axial ratio pattern of the antenna device shown in FIG. 3 achieved in a case where the height thereof is 8 mm.

FIG. 10C shows an axial ratio pattern of the antenna device shown in FIG. 3 achieved in a case where the height thereof is 11 mm.

FIG. 11 is a view showing a frequency characteristic of an axial ratio of the antenna device shown in FIG. 3 calculated in connection with a horizontal direction in a case where the height thereof is 11 mm.

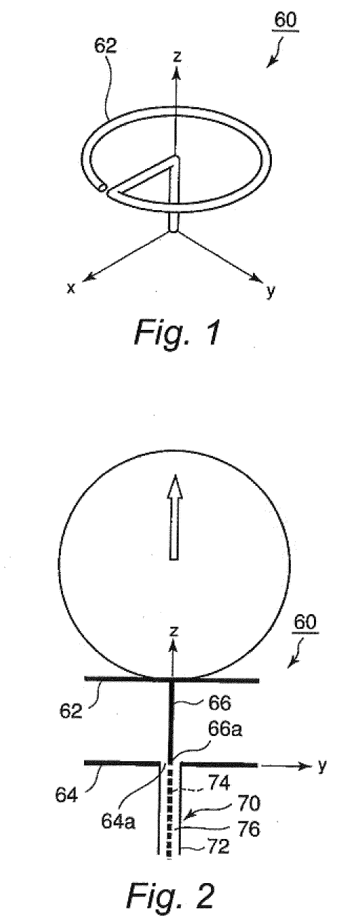

### DETAILED DESCRIPTIONS OF EXEMPLIFIED EMBODIMENTS

Exemplified embodiments of the invention are described below in detail with reference to the accompanying drawings.

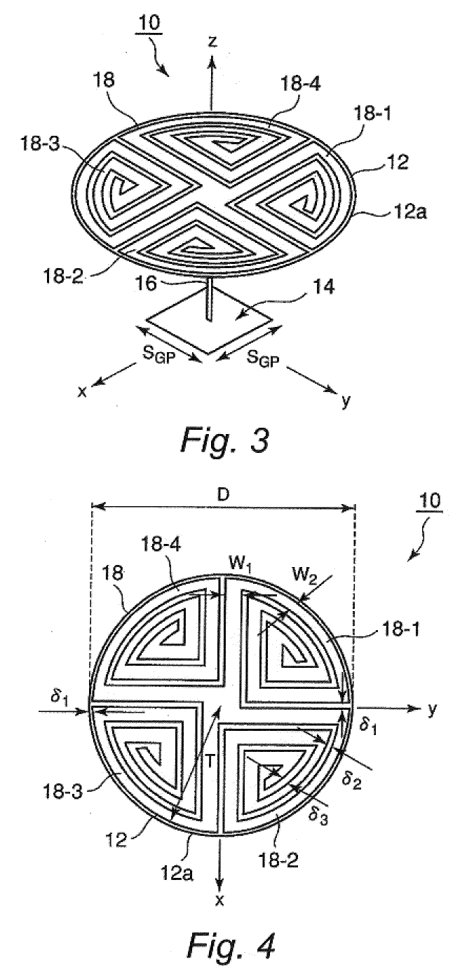

With reference to FIGS. 3 to 6, an antenna device 10 according to an embodiment of the present invention will be described. As shown in FIG. 3, in an orthogonal coordinate system (x, y, z), the center of a ground plate 14 to be described later is designated as an origin; the x-axis represents a longitudinal direction of the ground plate 14; the y-axis represents a lateral direction of the ground plate 14; and the z-axis represents a height direction of the ground plate 14. Consequently, the direction z is a normal direction of the ground plate 14. In the meantime, in FIG. 6, a direction orthogonal to a sheet is the x-axis; a lateral direction of the sheet is the y-axis; and a longitudinal direction of the sheet is the z-axis.

The antenna device 10 comprises a radiation element (an antenna element) to be described later; the ground plate 14 opposing the radiation element; and a feeder line 16 that extends upward in the z-axis direction from the ground plate 14 toward the radiation element. The ground plate 14 and the radiation element are arranged substantially parallel to each other.

The ground plate 14 extends within a plane parallel to an x-y plane defined by the x-axis and the y-axis. The illustrated ground plate 14 is shaped into a square each side of which has a length S_{GP}. A feeding point 16a of the feeder line 16 is provided at the substantial center of the ground plate 14. An insulator 14a, such as a through hole, is provided at the center of the ground plate 14. Consequently, the feeding point 16a and the ground plate 14 are not electrically connected together.

In an illustrated example, the ground plate 14 has the square shape but may also have another shape, such as circular shape.

The radiation element comprises a dielectric substrate 12 having a main face 12a and an antenna pattern 18 formed on the main face 12a of the dielectric substrate 12. The illustrated dielectric substrate 12 has circular shape having a diameter D. However, the shape of the dielectric substrate 12 is not limited to the circular shape and may also have regular polygon shape. The dielectric substrate 12 has a dielectric constant εᵣ and a thickness B. In the illustrated embodiment, the dielectric constant εᵣ is 3.4.

The ground plate 14 and the dielectric substrate 12 are separated from each other with an interval hₐᵢᵣ in the z-axis direction. Consequently, the antenna pattern 18 is provided at a position elevated (hₐᵢᵣ+B) from the ground plate 14.

In the illustrated embodiment, the antenna pattern 18 is formed with a strip conductor by printing, on the main face 12a of the dielectric substrate 12.

Specifically, the antenna pattern 18 has a four-fold rotationally symmetric shape of which a rotationally symmetric axis is the feeder line 16. The antenna pattern 18 consists of first to fourth spiral conductor patterns 18-1, 18-2, 18-3, and 18-4. The first to fourth spiral conductor patterns 18-1 to 18-4 radially extend in all directions from the center of the dielectric substrate 12 and are arranged at an equiangular interval of 90° around the center of the dielectric substrate 12. Each of the first to fourth spiral conductor patterns 18-1 to 18-4 is made from a strip conductor.

Each of the first to fourth spiral conductor patterns 18-1 to 18-4 has a clockwise swirl around the center of the dielectric substrate 12 when viewed from above. Therefore, the antenna device 10 is an antenna device that emits a right-handed circularly-polarized wave.

The length of one side of the square ground plate 14 is S_{GP}. The radius of an outer periphery of the antenna pattern 18 is labeled as “r.”Incidentally, a proportion of “r” to the value “S_{GP}/2” is 3 to 1 (i.e., the ratio of “r:S_{GP}/2” is 3:1).

As shown in FIG. 4, each of the first to fourth spiral conductor patterns 18-1 to 18-4 comprises: a first linear strip conductor extending from the center of the dielectric substrate 12 to the outside in a first direction parallel to a radial direction of the antenna pattern; a first arcuate strip conductor (the outermost arcuate section) extending from a leading end of the first linear strip conductor in a circumferential direction of the antenna pattern; a second linear strip conductor extending from the leading end of the first arcuate strip conductor to the inside of the dielectric substrate 12 in a second direction parallel to a radial direction of the antenna pattern; a third linear strip conductor extending from a leading end of the second linear strip conductor to the outside of the dielectric substrate 12 in the a third direction parallel to a radial direction of the antenna pattern; a second arcuate strip conductor (an intermediate arcuate section) extending from a leading end of the third linear strip conductor in the circumferential direction; a fourth linear strip conductor extending from the leading end of the second arcuate strip conductor to the inside of the dielectric substrate 12 in the substantially-radial direction; a fifth linear strip conductor extending from a leading end of the fourth linear strip conductor to the outside of the dielectric substrate 12 in a fifth direction parallel to a radial direction of the antenna pattern; and a third arcuate strip conductor (the innermost arcuate section) extending from a leading end of the fifth linear strip conductor in the circumferential direction. The first to third arcuate strip conductors may extend straight. Although the spiral conductor pattern according to the present embodiment includes five linear strip conductors and three arcuate strip conductors, the spiral conductor pattern may include at least two linear strip conductors and at least one arcuate conductor so as to form a loop. Further, the spiral conductor pattern may include more than five linear strip conductors and more than three arcuate strip conductors.

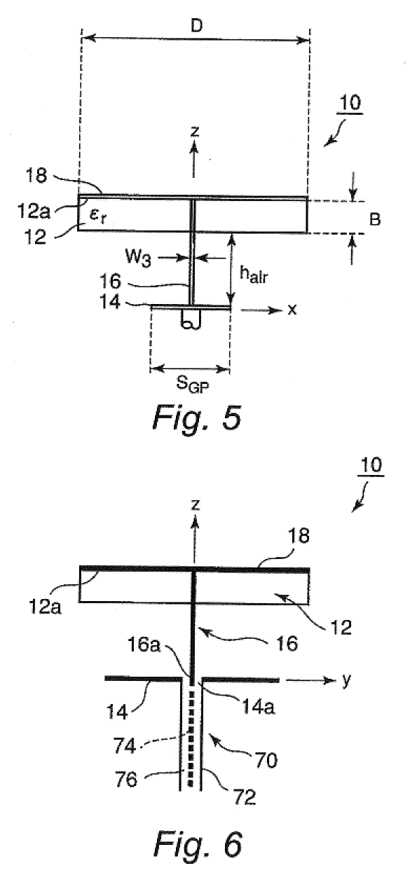

Each of the first to fifth linear strip conductors has a first width W₁, and each of the first to third arcuate strip conductors has a second width W₂. In the meantime, as shown in FIG. 5, the feeder line 16 has a thickness W₃.

As shown in FIG. 4, a first gap δ₁ is formed between an outer periphery of the first arcuate strip conductor and the outer periphery of the dielectric substrate 12. A second gap δ₂ is formed between an inner periphery of the first arcuate strip conductor and an outer periphery of the second arcuate strip conductor. A third gap δ₃ is formed between an inner periphery of the second arcuate strip conductor and an outer periphery of the third arcuate strip conductor.

As shown in FIG. 6, the antenna device 10 is supplied with power feed by use of a coaxial cable 70. The coaxial cable 70 is an electrical signal transmitting member that coaxially includes a cylindrical outer conductor 72 and a center conductor 74 located at the center of the outer conductor. The outer conductor 72 and the center conductor 74 are insulated from each other by a cylindrical insulator 76. The outer conductor 72 is covered with a sheath (not shown).

As shown in FIG. 6, a leading end of the center conductor 74 of the coaxial cable 70 is electrically connected to the feeding point 16a by solder (not shown). A leading end of the outer conductor 72 of the coaxial cable 70 is electrically connected to the ground plate 14 by solder (not shown).

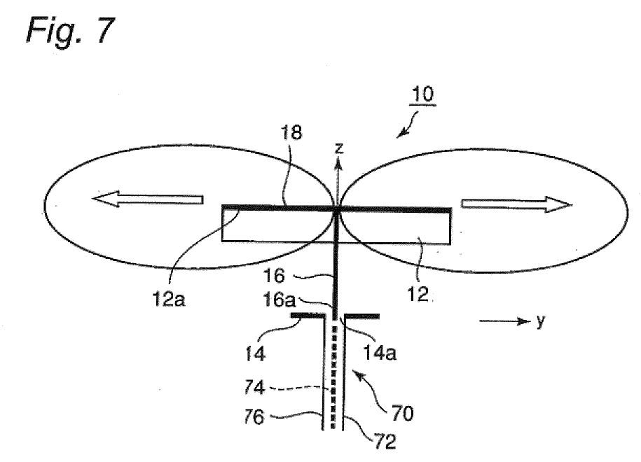

As shown in FIG. 7, the antenna device 10 exhibits a superior circularly-polarized wave characteristic in all directions within a horizontal plane of the antenna.

The antenna device 10 of the illustrated embodiment is designed such that a working frequency f has a value of 2.75 GHz. Under the circumstance, specific dimensions of the foregoing antenna device 10 are as follows.

The first width W₁ is 4 mm, and the second width W₂ is 2 mm. The thickness W₃ 16 is 1 mm. The first gap δ₁ is 1 mm; the second gap δ₂ is 1.5 mm; and the third gap δ₃ is 2.5 mm. The circumferential diameter r is 30.5 mm, and the diameter D is 63 mm. The length S_{GP} is 22 mm. A space hₐᵢᵣ between the ground plate 14 and the dielectric substrate 12 is 11 mm. The thickness B is 1 mm.

The first arcuate strip conductor of each of the first to fourth spiral conductor patterns 18-1 to 18-4 has an arm length Lₐᵣₘ, for example, “a” to “b”

TABLE 1

| f | 2.75 GHZ |
|---|---|
| λ_{2.75} | 109 mm |
| λ_{g2.75} | 73.6 mm |
| W₁ | 4 mm |
| W₂ | 2 mm |
| W₃ | 1 mm |
| 2r | 0.836λ_{g2.75} |
| D | 0.856λ_{g2.75} |
| S_{GP} | 0.202λ_{2.75} |
| hₐᵢᵣ | 0.1012λ_{2.75} |
| B | 1 mm |
| εᵣ | 3.4 |

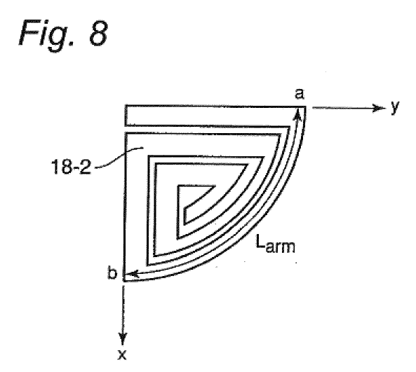

shown in FIG. 8. In an illustrated embodiment, the arm length Lₐᵣₘ is set so as to come to about three-fifths of a working wavelength λ_{g2.75} acquired after the working frequency f=2.75 GHz has undergone wavelength shortening in the dielectric substrate 12.

The working frequency f=2.75 GHz of the antenna device 10 is determined from the arm length Lₐᵢᵣ=0.614λ_{2.75} and the height hₐᵢᵣ=0.10λ_{g2.75} of the upright section 16.

In the illustrated embodiment, explanations are provided by taking, as an example, the case where the working frequency f of the antenna device 10 is set to 2.75 GHz. Table 1 shows results acquired by normalized dimensions and parameters of the antenna device 10 by the working wavelength λ_{g2.75}.

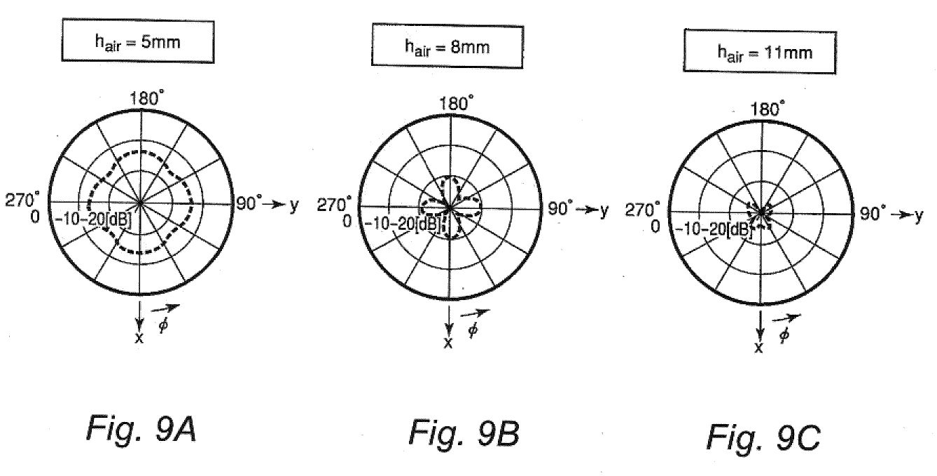

FIGS. 9A to 9C are views showing radiation patterns developing within the x-y plane when the working frequency f of the antenna device 10 is 2.75 GHz and when the distance hₐᵢᵣ between the ground plate 14 and the dielectric substrate 12 (hereinafter simply called a “height”) is changed. In FIGS. 9A to 9C, a solid line designates a right-handed circularly-polarized wave component, and a dashed line designates a left-handed circularly-polarized wave component.

As can be seen from FIGS. 9A, 9B, and 9C, an orthogonally-polarized wave component E_{L} increases as the height hₐᵢᵣ is increased.

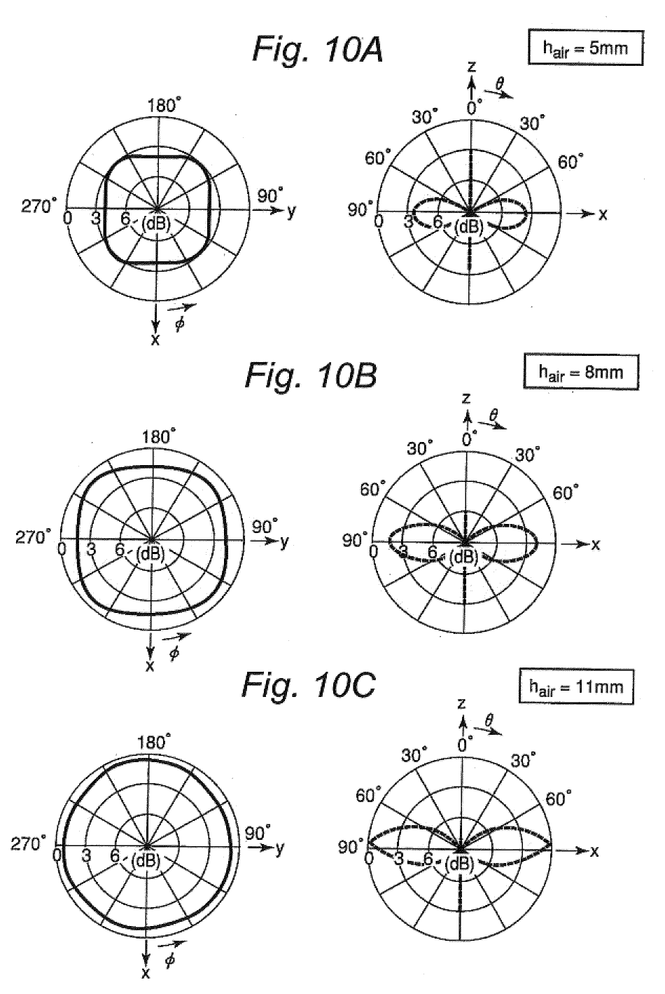

FIGS. 10A to 10C are views showing axial ratio patterns achieved when the height hₐᵢᵣ is changed on condition that the working frequency f of the antenna device 10 is 2.75 GHz. In respective FIGS. 10A, 10B, and 10C, the left side shows an axial ratio achieved within the x-y plane, and the right side shows an axial ratio achieved within the x-z plane.

As can be seen from FIGS. 10A, 10B, and 10C, a height hₐᵢᵣ at which the axial ratio becomes to 3 dB or less is present in the x-y plane so as to be shown in the left side (hₐᵢᵣ=8 mm) in FIG. 10B and the left side (hₐᵢᵣ=11 mm) in FIG. 10C. At this time, an angle width at which the axial ratio comes to 3 dB or less within the x-z plane is understood to be about 30°.

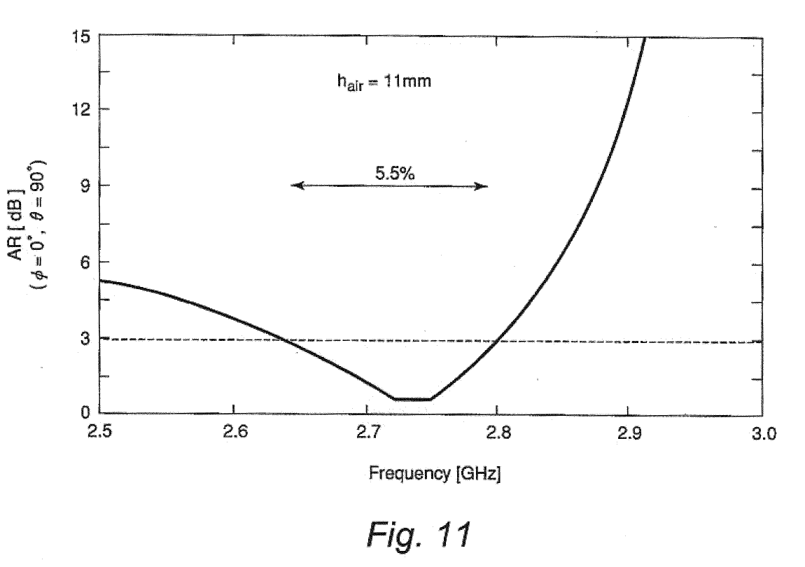

In FIG. 11, a horizontal axis shows a frequency [GHz], and a vertical axis shows an axial ratio AR [dB]. FIG. 11 shows that the axial ratio AR is 3 dB or less within a range where the frequency ranges from about 2.64 GHz to 2.8 GHz. The circularly-polarized wave band is about 5.5%.

As is evident from above descriptions, an antenna device can have a nondirectional circularly-polarized wave characteristic within the antenna plane by selected an appropriate value for the height hₐᵢᵣ.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

For instance, the antenna pattern may have an eight-fold rotationally symmetric shape or a 16-fold rotationally symmetric shape. In general, the antenna pattern may have an N-fold rotationally symmetric shape (N is an integer of three or more). In this case, the antenna pattern consists of the first to N-th spiral conductor patterns that radially extend in all directions from the center of the dielectric substrate and that are arranged at an equiangular interval (360°/N) around the center of the dielectric substrate. When a left-handed circularly-polarized wave is emitted, the substantial requirement is that each of the first to N-th spiral conductor patterns should have a counterclockwise swirl around the center of the dielectric substrate when viewed from above.

In a case that the antenna pattern 18 has rigidity, for example that the antenna pattern 18 is formed by sheet-metal, the radiation element may be configured without the dielectric substrate 12.

What is claimed is:

1. An antenna device, comprising:
a plurality of loop elements made of conductive material, and constituting a planar antenna element having N-fold rotationally symmetric shape with respect to a center portion of the planar antenna element, the N being an integer of three or more, each of the loop elements including:
at least two first elements extending in a first direction parallel to a radial direction of the planar antenna element; and
at least one second element extending in a circumferential direction of the planar antenna element;
a ground plate made of conductive material and opposing the planar antenna element; and
a power feeding line extending from the ground plate to the planar antenna element, and electrically connected to the planar antenna element at the center portion.

2. The antenna device as set forth in claim 1, further comprising:
a dielectric substrate on which the planar antenna element mounted.

3. The antenna device as set forth in claim 2, wherein:
the dielectric substrate has circular shape.

4. The antenna device as set forth in claim 2, wherein:
a gap is formed between the dielectric substrate and the ground plate.

5. The antenna device as set forth in claim 1, wherein:
the planar antenna element has circular shape.

6. The antenna device as set forth in claim 1, wherein:
the ground plate has square shape.

7. The antenna device as set forth in claim 6, wherein:
a radius of the planar antenna element is 1.5 times a length of a side of the ground plate.

8. The antenna device as set forth in claim 1, wherein:
each of the loop elements includes a peripheral portion forming an outer periphery of the planar antenna element; and
a length of the peripheral portion is three-fifths of a working wavelength obtained by shortening a wavelength corresponding to working frequency of the antenna device with the dielectric substrate.

9. The antenna device as set forth in claim 1, wherein:
the N is multiple of four.

10. The antenna device as set forth in claim 9, wherein:
the N is four.

11. The antenna device as set forth in claim 1, wherein:
each of the loop elements swirls clockwise when viewed from a side of the planar antenna element opposite to a side that the ground plate is disposed so as to radiate right-handed circularly polarized waves.
